(19) United States
(12) Patent Application Publication
(10) Pub. No.: US 2020/0369412 A1
(43) Pub. Date: Nov. 26, 2020

(54) AUTOMATIC CONTROL SYSTEM FOR SPACE STATION

(71) Applicant: Beijing Space Quest Co., LTD., Beijing City (CN)

(72) Inventor: SUQUAN DING, Beijing City (CN)

(21) Appl. No.: 16/729,477

(22) Filed: Dec. 29, 2019

(30) Foreign Application Priority Data
May 24, 2019 (CN) 201910436718.8

(51) Int. Cl. B64G 1/36; B64G 1/10; B64G 1/46; B64G 1/44

(52) U.S. Cl. CPC B64G 1/363; B64G 1/443; B64G 1/46; B64G 1/105

(57) ABSTRACT

In the system of the system of the present invention, the detection processing device detects whether there is any target orbiting craft; the acquisition processing device acquires a surface image of said solar panels after detecting the target orbiting craft; the shadow feature data processing device analyzes the acquired surface image of solar panels to detect whether there is any shadow feature data; the trigger processing device triggers starting power ensuring control for the environment control and life support system after detecting the shadow feature data; the matching processing device matches said shadow feature data with the above-mentioned preset shadow feature data cast by the target orbiting craft on said solar panels, and if they match each other, continue to power said experiment cabin to prevent data loss of the experiment cabin, which can effectively avoid unnecessary experimental data loss of the space station.

### FIELD OF THE INVENTION

The present invention relates to the aerospace technology field, and more particularly to an automatic control system for preventing loss of experimental data of a space station.

### BACKGROUND

A space station is also called as a spaceport. It is a manned spacecraft that runs in a near-earth orbit for a long time and is configured for visiting, long term work and life for multiple astronauts.

In general, a space station is powered by a solar panel for operation. When an orbiting craft is approaching the space station, the orbiting craft might cast its shadow on the solar panels, leading to reduced power supply. Due to the reduced supply of the solar panel, the control center of the space station will decrease the load to ensure power supply for the environmental control and life support system, thereby turning off experiment cabins that consumes much power, which would cause loss of data collected by the experiment cabins. However, the power supply reduction caused by the orbiting craft lasts for a short time during which the experiment cabins need not to be closed to cause unnecessary data loss of the cabins.

### SUMMARY OF THE INVENTION

The technical problem to be addressed by the present invention is to provide an automatic control system for a space station to avoid unnecessary experimental data loss of the space station.

In order to address the above technical problem, the present invention adopts the following technical solution.

An automatic control system for a space station is provided, said space station having solar panels, an experiment cabin powered by said solar panels and an environment control and life support system, wherein experiment cabin acquires experimental data, said environment control and life support system controls to provide astronauts with basic life conditions and suitable working environment, the system comprising:

a storage device for storing preset shadow feature data cast by said target orbiting craft on said solar panels;

a detection processing device configured to detect whether there is an orbiting craft;

an acquisition processing device configured to acquire a surface image of said solar panel after detecting the target orbiting craft;

a shadow feature data processing device configured to analyze said acquired surface image of the solar panels to detect whether there is any shadow feature data;

a trigger processing device is configured to start power ensuring control for the environment control and life support system after any shadow feature data is detected;

a matching processing device configured to match said shadow feature data with said preset shadow feature data cast by the target orbiting craft on said solar panels, and continue to power said experiment cabin to prevent data loss of said experiment cabin.

The preset shadow feature data cast by the target orbiting craft on said solar panels is the shadow distribution region data cast by said target orbiting craft on said solar panels.

Said shadow feature data processing device may specifically comprise:

a gray scale and partitioning processing module configured to subject the acquired surface image of the solar panels to gray scale and partitioning processing;

a determination processing module configured to determine whether there is any shadow and shadow distribution region data according to the acquired gray values and partitioning values;

and a storage processing module configured to store said determined shadow distribution region data as the shadow feature data.

In addition, the system further includes an adjusting processing device configured to adjust an attitude of the solar panels after detecting the shadow feature data to increase a shined area of the solar panel so as to increase power supply, allowing the solar panels to continue powering said experiment cabin to prevent data loss of said experiment cabin.

In addition, the system further includes a backup processing device configured to back up experiment cabin data collected previously after detecting the target orbiting craft.

In addition, the system further includes an alarming processing device configured to sound alarm to a control center of the space station after detecting the target orbiting craft, allowing the control center of the space station to determine that solar panels continue powering said experiment cabin to prevent data loss of said experiment cabin.

As compared to prior art, the present invention has the following beneficial effects.

The system of the present invention includes a storage device, a detection processing device, an acquisition processing device, a shadow feature data processing device, a trigger processing device and a matching processing device, wherein the storage device stores preset shadow feature data cast by said target orbiting craft on said solar panels; the detection processing device detects whether there is any target orbiting craft; the acquisition processing device acquires a surface image of said solar panels after detecting the target orbiting craft; the shadow feature data processing device analyzes the acquired surface image of solar panels to detect whether there is any shadow feature data; the trigger processing device triggers starting power ensuring control for the environment control and life support system after detecting the shadow feature data; the matching processing device matches said shadow feature data with the above-mentioned preset shadow feature data cast by the target orbiting craft on said solar panels, and if they match each other, continue to power said experiment cabin to prevent data loss of the experiment cabin, which can effectively avoid unnecessary experimental data loss of the space station.

### BRIEF DESCRIPTION OF DRAWINGS

FIG. 1 is a diagram of a solar panel applied to a space station according to the present invention;

FIG. 2 is a diagram showing distribution of shadows cast on the solar panel by the orbiting craft applied in the present invention;

FIG. 3 is a block diagram of a first embodiment of an automatic control system applied in a space station according to the present invention;

FIG. 4 is a block diagram of an embodiment of a shadow feature data processing device in an automatic control system applied in a space station according to the present invention;

FIG. 5 is a block diagram of a second embodiment of an automatic control system applied in a space station according to the present invention;

FIG. 6 is a block diagram of a third embodiment of an automatic control system applied in a space station according to the present invention;

FIG. 7 is a block diagram of a fourth embodiment of an automatic control system applied in a space station according to the present invention.

### DETAILED DESCRIPTION

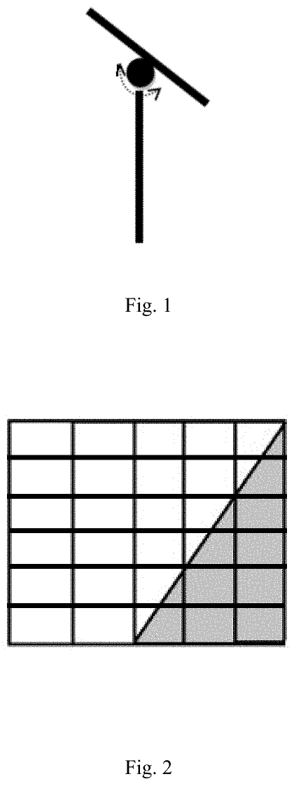

The space station of the present invention includes solar panels, an experiment cabin and an environmental control and life support system powered by said solar panel, in which the solar panels are devices for powering the spacecraft. Their working environment is the space near vacuum with extremely low external resistance. The solar panels feature large structure size, low rigidity and high flexibility and are generally composed by several solar cell panels, referring to FIG. 1, which is a diagram of a solar panel for a space station applied in the present invention. In addition, the experiment cabin is mainly for acquiring experimental data, and the environment control and life support system is mainly for controlling to provide basic life conditions and suitable work environment for astronauts. In practice, a space station further includes other functional systems which will not be described herein.

It is noted that an orbiting craft is an aerospacecraft flying in a predetermined space orbit that may provide transport service for the space station. The orbiting craft has a fixed volume and a fixed and regular flying trajectory. The operating trajectory of the solar panels is also regular. Therefore, the distribution regions of shadows cast by the orbiting craft onto the surfaces of the solar panels may be calculated in advance. For example, the shadow regions casted by the orbiting craft onto the solar panels may be calculated according to the modern astronomy algorithm proposed by the Belgium astronomer Jean Meeus, referring to FIG. 2, which is a diagram showing distribution regions of shadows cast by the orbiting craft onto the solar panels applied in the present invention. It is to be noted that this figure is just an example. In practice, when adjusting the flying trajectory of the solar panels and the flying attitude, distribution regions of shadows cast by the orbiting craft onto the solar panels change accordingly, which will not be described in detail herein.

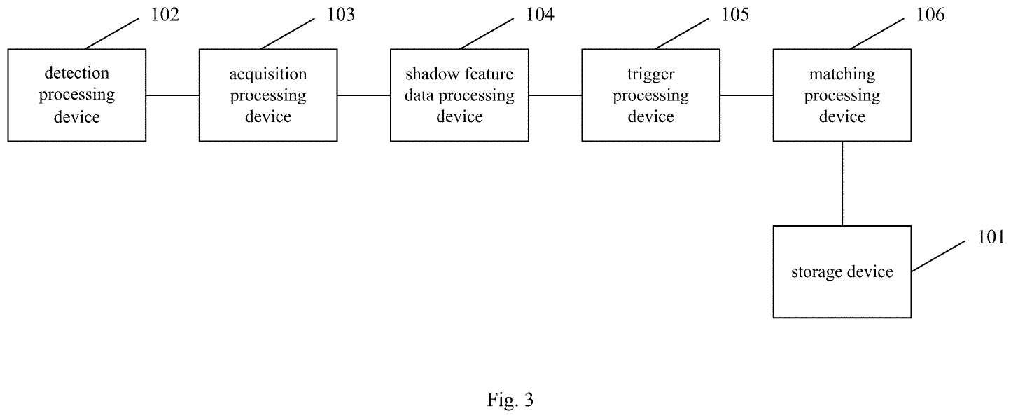

Referring to FIG. 3, which is a block diagram of a first embodiment of the automatic control system applied in the space station according to the present invention, the automatic control system of the present embodiment includes specifically: a storage device 101, a detection processing device 102, an acquisition processing device 103, a shadow feature data processing device 104, a trigger processing device 105 and a matching processing device 106.

The storage device 101 stores preset feature data on shadow cast by said orbiting craft on said solar panels in the present embodiment. In specific implementation, it is possible to locate the projection of the target orbiting craft on said solar panels and acquire the shadow feature data at the corresponding location. Said preset shadow distribution region data cast by said target orbiting craft on said solar panels is the shadow distribution region data cast by said orbiting craft on said solar panels. In practice, the entire surface of the solar panels is divided into individual square or triangle grids (or other shapes of grids, which is not limited herein). The area of the square or triangle grid may be adjusted according to practical conditions. The square grids may be scaled down if high precision is required. It is noted that the shadow distribution regions as shadow feature data in the present invention may be a range of the shadow distribution regions formed by the orbiting craft in the whole period, or a range of the shadow distribution region at an instance at which the orbiting craft forms the shadow.

The detection processing device 102 in the present embodiment is configured to detect whether there is an orbiting craft.

The acquisition processing device 103 in the present embodiment acquires a surface image of said solar panel after detecting the target orbiting craft.

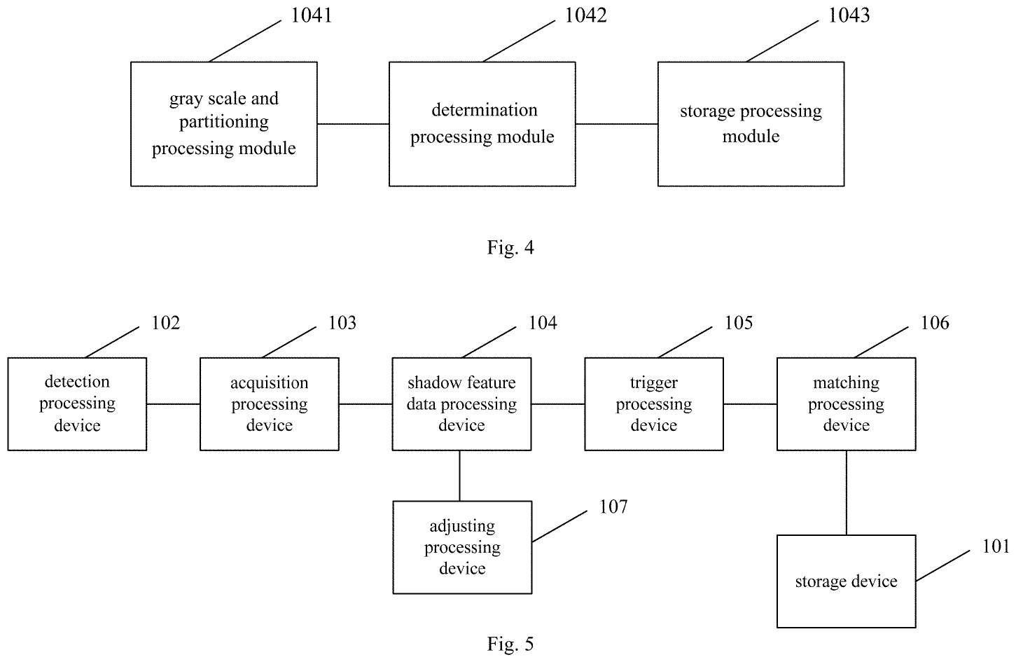

The shadow feature data processing device 104 in the present embodiment is configured to analyze the acquired surface image of the solar panel to detect whether there is any shadow feature data. In specific implementation, referring to FIG. 4, for example as an embodiment, the shadow feature data processing device 104 may include the following processing modules: the gray scale and partitioning processing module 1041, the determination processing module 1042 and the storage processing module 1043, wherein:

the gray scale and partitioning processing module 1041 is configured to subject the acquired surface image of the solar panel to gray scale and partitioning processing;

the determination processing module 1042 is configured to determine whether there is any shadow and shadow distribution region data according to the acquired gray values and partitioning values;

and the storage processing module 1043 is configured to store said determined shadow distribution region data as the shadow feature data.

It is noted that in specific implementation, for example, it is possible to use a normalized cross-correlation function to detect shadows and the location may be determined according to the above-described square grids for partitioning with each small square grid being one location point. The shadow distribution regions are located according to square grids where the shadows locate to obtain the shadow distribution region data. In addition, while acquiring the surface image of the solar panel, it is possible to acquire images from multiple angles by multiple cameras, and while analyzing the acquired surface image of the solar panel, it is possible to use the weighed average strategy algorithm to process image of the multiple angles, thereby realizing pixel-level fusion and improving accuracy.

The trigger processing device 105 in the present embodiment needs to start power ensuring control for the environment control and life support system if any shadow feature data is detected since the solar panel is shielded which may cause shortage of power supply.

The matching processing device 106 in the present embodiment matches said shadow feature data with the preset shadow feature data cast by the target orbiting craft on said solar panel. If they match, said experiment cabin will be powered continuously to prevent data loss of the cabin which may avoid unnecessary loss of experimental data. It is noted that during specific matching, it may be precise matching or fuzzy matching wherein precise matching is to precisely match shadow feature data detected at a predetermined instant with the preset shadow feature data at the predetermined instant, while the fuzzy matching is to match shadow feature data detected at a predetermined instant with the preset shadow feature data in the entire period during which the orbiting craft forms shadow (that is, the range of shadow distribution regions over the entire period during which the orbiting craft forms shadow) and it may be determined they match each other if only it is in the preset shadow distribution region range.

In addition, as a preferred embodiment, referring to FIG. 5, this figure is a block diagram of a second embodiment of the automatic control system applied to the space station according to the present invention. the present embodiment is different from the above-mentioned first embodiment in that the present embodiment further includes an adjusting processing device 107. After detecting the shadow feature data, the adjusting processing device 107 may increase the shined are of the solar panel by adjusting attitude of the solar panel. When the shined area of the panel increases, the power supply amount of the solar panel increases accordingly, allowing the solar panel continue to power said experiment cabin to prevent data loss of the experiment cabin.

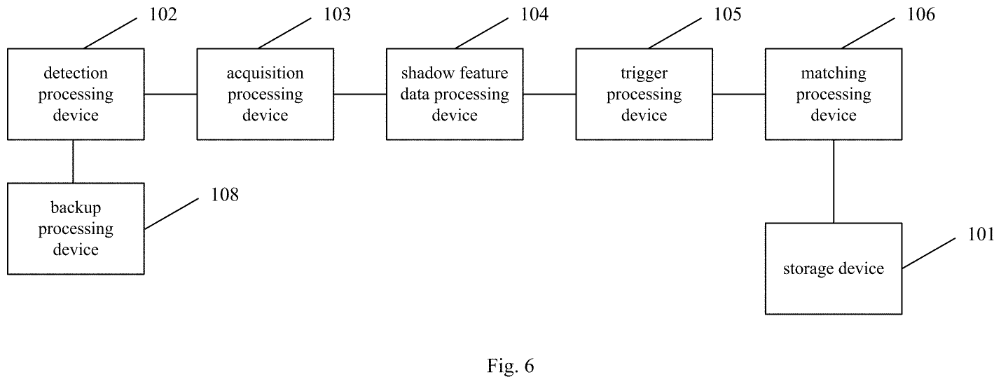

In addition, as another preferred embodiment of the present invention, referring to FIG. 6, which is a block diagram of a third embodiment of the automatic control system applied in a space station according to the present invention, the present embodiment is different from the above-mentioned embodiment in that the system in the present embodiment further includes a backup processing device 108. The backup processing device 108 backs up experiment cabin data acquired previously while detecting a target orbiting craft. In specific implementation, if a target orbiting craft is detected, the experiment cabin might be powered off by the energy control system of the space station. Therefore, if a target orbiting craft is detected, it is possible to back up data of the experiment cabin to prevent data loss.

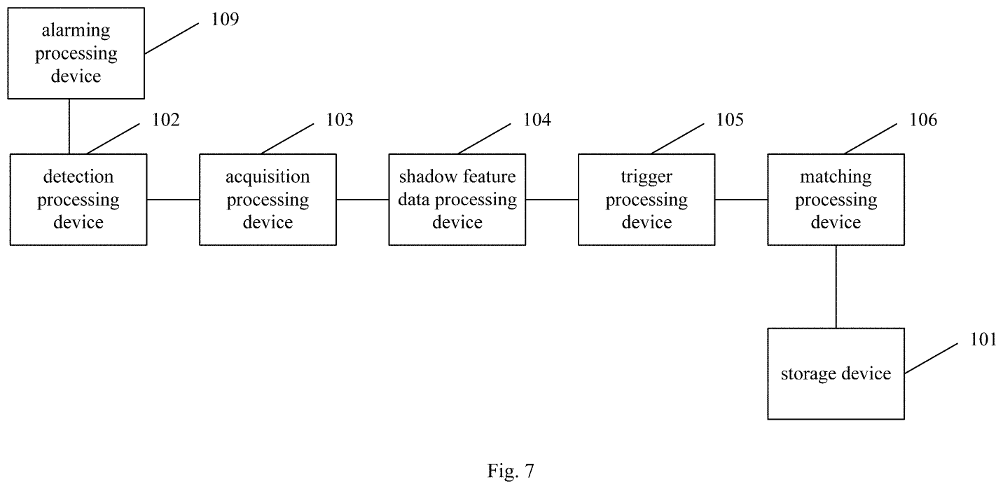

In addition, as another preferred embodiment of the present invention, referring to FIG. 7, which is a block diagram of a fourth embodiment of the automatic control system applied in a space station according to the present invention, the present embodiment is different from the above-mentioned embodiment in that the system in the present embodiment further includes an alarm processing device 109. The alarm processing device 109 sounds alarm to the control center of the space station after detecting any target orbiting craft. In specific implementation, if a target orbiting craft is detected, since the experiment cabin might be powered off by the energy control system, the control center of the space station may determine that power shortage is caused by the orbiting craft via alarming for a not long period, which allows continuing to power the experiment cabin by the solar panel to prevent data loss of the experiment cabin.

In addition, although the solar panel works in an environment near vacuum, it might be influenced by external interference such as particle streams and generate resonance. The resonance attenuates very slow, which causes inaccurate location of the solar panel. As a preferred embodiment, the automatic control system in the present invention further includes a resonance control element, a resonance sensor and a resonance controller disposed on the solar panel. Said resonance sensor detects resonance signals. Said resonance controller determines resonance suppression signals according to the resonance signals transmitted from said resonance sensor and sends the resonance signals to the resonance control element. Said resonance control element generates an active control force according to the resonance suppression signals to suppress resonance, thereby suppressing resonance rapidly and allowing more accurate location of the solar panel.

What have been discussed above are only present inventions of the present invention and are not intended to limit the present invention. Any modifications, equivalent substitutions and improvements made in the spirit and principle of the present invention are all should be encompassed in the scope of the present invention.

What is claimed is:

1. An automatic control system for a space station, wherein said space station has solar panels, an experiment cabin powered by said solar panels and an environment control and life support system, wherein experiment cabin acquires experimental data, said environment control and life support system controls to provide astronauts with basic life conditions and suitable working environment, the system comprising:
a storage device for storing preset shadow feature data cast by said target orbiting craft on said solar panels;
a detection processing device configured to detect whether there is an orbiting craft;
an acquisition processing device configured to acquire a surface image of said solar panel after detecting the target orbiting craft;
a shadow feature data processing device configured to analyze said acquired surface image of the solar panels to detect whether there is any shadow feature data;
a trigger processing device is configured to start power ensuring control for the environment control and life support system after any shadow feature data is detected; and
a matching processing device configured to match said shadow feature data with said preset shadow feature data cast by the target orbiting craft on said solar panels, and continue to power said experiment cabin to prevent data loss of said experiment cabin.

2. The system of claim 1, wherein the preset shadow feature data cast by the target orbiting craft on said solar panels is the shadow distribution region data cast by said target orbiting craft on said solar panels.

3. The system of claim 1, wherein said shadow feature data processing device comprises:
a gray scale and partitioning processing module configured to subject the acquired surface image of the solar panels to gray scale and partitioning processing;
a determination processing module configured to determine whether there is any shadow and shadow distribution region data according to the acquired gray values and partitioning values;
and a storage processing module configured to store said determined shadow distribution region data as the shadow feature data.

4. The system of claim 1, further comprising an adjusting processing device configured to adjust an attitude of the solar panels after detecting the shadow feature data to increase a shined area of the solar panel so as to increase power supply, allowing the solar panels to continue powering said experiment cabin to prevent data loss of said experiment cabin.

5. The system of claim 1, further comprising a backup processing device configured to back up experiment cabin data collected previously after detecting the target orbiting craft.

6. The system of claim 1, further comprising an alarming processing device configured to sound alarm to a control center of the space station after detecting the target orbiting craft, allowing the control center of the space station to determine that solar panels continue powering said experiment cabin to prevent data loss of said experiment cabin.
